(19) United States
(12) Patent Application Publication
(10) Pub. No.: US 2016/0221001 A1
(43) Pub. Date: Aug. 4, 2016

(54) ELECTROSTATIC BLOWER AND METHODS OF ASSEMBLING THE SAME

(71) Applicant: Regal Beloit America, Inc., Beloit, WI (US)

(72) Inventor: William Stuart Gatley, JR., Cassville, MO (US)

(21) Appl. No.: 14/916,857

(22) PCT Filed: Sep. 4, 2014
(86) PCT No.: PCT/US14/54014

§ 371 Date: Mar. 4, 2016

Related U.S. Application Data
(60) Provisional application No. 61/874,082, filed on Sep. 5, 2013.

(51) Int. Cl. B03C 3/12; B03C 3/47; F24H 3/00; B03C 3/41

(52) U.S. Cl. CPC B03C 3/12; B03C 3/41; B03C 3/47; F24H 3/00; B03C 2201/04

(57) ABSTRACT

An electrostatic blower for moving a flue gas is provided. The electrostatic blower includes a power source and a housing coupled to the power source. The housing includes an inlet end and a discharge end. A corona discharge device is coupled to the power source and to the housing. The corona discharge device is configured to ionize the flue gas. The electro-static blower includes a collector device coupled to the housing at a position downstream from said corona discharge device with respect to a flow of the flue gas within said housing. The collector is configured to attract the ionized flue gas from the corona discharge device.

### BACKGROUND OF THE INVENTION

The embodiments described herein relate generally to electrostatic blowers, and more particularly, to methods and systems for exhausting a flue gas from a gas-fired appliance.

Gas-fired appliances are used to ignite a fuel for heating purposes. A typical gas-fired appliance such as, for example, a gas-fired water heater, ignites natural gas to heat water for further use by a facility such as a home or other building. Conventionally, during combustion of the fuel, the gas-fired appliance generates flue gases. For at least efficiency and safety reasons, the flue gases should be vented from the gas-fired appliance and away from the facility.

Some gas-fired appliances are categorized by an efficiency rate. Condensing appliances are sometimes categorized having a 90% efficiency rating and non-condensing appliances are sometimes categorized having an 80% efficiency rating. Save conventional condensing appliances generate the flue gas to induce a natural convection, based on pressure differences, which allows the flue gas to flow from a combustion zone and into a vent. Conventional non-condensing appliances, however, may generate the flue gas with a lower temperature as compared to the temperature of condensing appliances.

With lower combustion temperatures than conventional condensing appliances, conventional non-condensing appliances may use an electromechanical fan or blower that is coupled to an outlet of the combustion zone. The fan is configured to move the flue gas from the combustion zone and through the vent. The fan, however, may increase the manufacturing, operational and/or maintenance costs of the non-condensing appliance. Moreover, the added fan may increase the space needed for the non-condensing appliance. Still further, the fan may produce unwanted noise during operation of the non-condensing appliance.

### BRIEF DESCRIPTION OF THE INVENTION

In one aspect, an electrostatic blower for moving a flue gas is provided. The electrostatic blower includes a power source and a housing coupled to the power source. The housing includes an inlet end and a discharge end. A corona discharge device is coupled to the power source and to the housing. The corona discharge device is configured to ionize the flue gas. The electrostatic blower includes a collector device coupled to the housing at a position downstream from said corona discharge device with respect to a flow of the flue gas within said housing. The collector is configured to attract the ionized flue gas from the corona discharge device.

In another aspect, a gas appliance is provided. The gas appliance includes a combustor configured to combust a fuel and to generate a flue gas. An electrostatic blower is coupled to the combustor and includes a power source and housing coupled to the power source. The housing includes an inlet end and a discharge end. A corona discharge device is coupled to the power source and to the housing. The corona discharge device is configured to ionize the flue gas. The gas appliance also includes a collector device coupled to the housing at a position downstream from said corona discharge device with respect to a flow of the flue gas within said housing. The collector device is configured to attract the ionized flue gas from the corona discharge device. A vent is coupled to the discharge end.

Still further, in another aspect, a method of assembling an electrostatic blower is provided. The method includes coupling a power source to a housing having an inner surface, an outer surface, an inlet end and a discharge end. A plurality of corona wires is coupled to the inner surface and near the inlet end. The method also includes coupling the power source to the plurality of corona wires. Further, the method includes coupling a plurality of collector plates to the inner surface and near the discharge end.

### BRIEF DESCRIPTION OF THE DRAWINGS

FIG. 1 is a perspective of an exemplary electrostatic blower.

FIG. 2 is a schematic view of the electrostatic blower shown in FIG. 1 coupled to a combustion system.

FIG. 3 illustrates an exemplary flowchart illustrating a method of assembling an electrostatic blower.

### DETAILED DESCRIPTION OF THE INVENTION

The embodiments described herein relate to electrostatic blowers and methods of assembling the electrostatic blower. The embodiments relate to an electrostatic blower that is coupled to a combustion system to facilitate exhausting flue gases from the combustion system. More particularly, the embodiments relate to a corona discharge device and a collector device coupled to a non-condensing gas-fired appliance. It should be understood that the embodiments described herein for electrostatic blowers are not limited to non-condensing, gas-fired appliances, and further understood that the descriptions and figures that utilize corona discharge wires, collector plates, and a water heater are exemplary only.

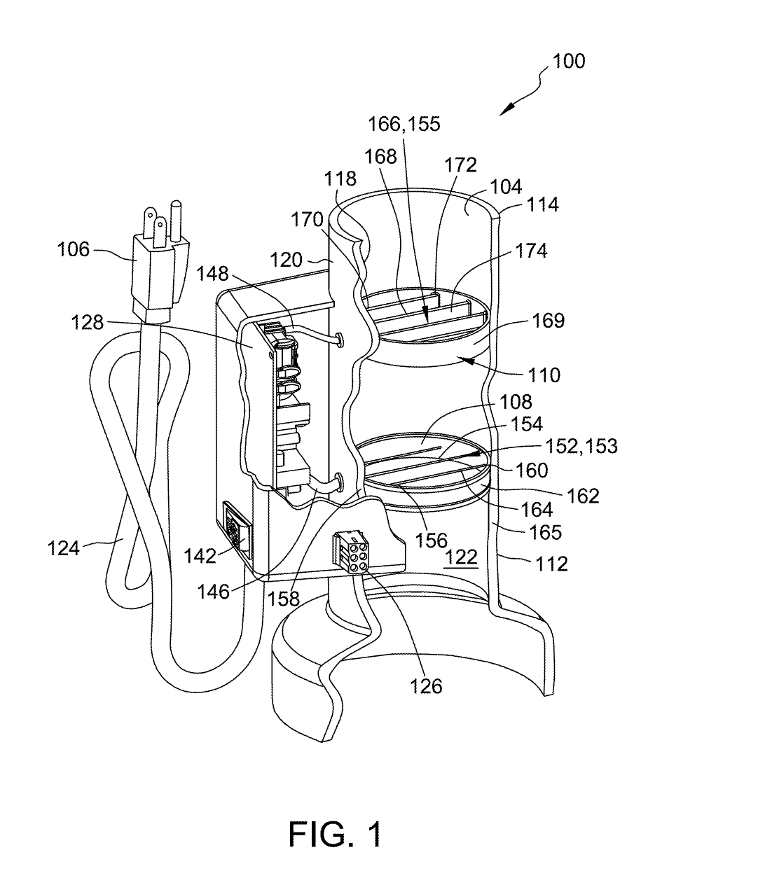

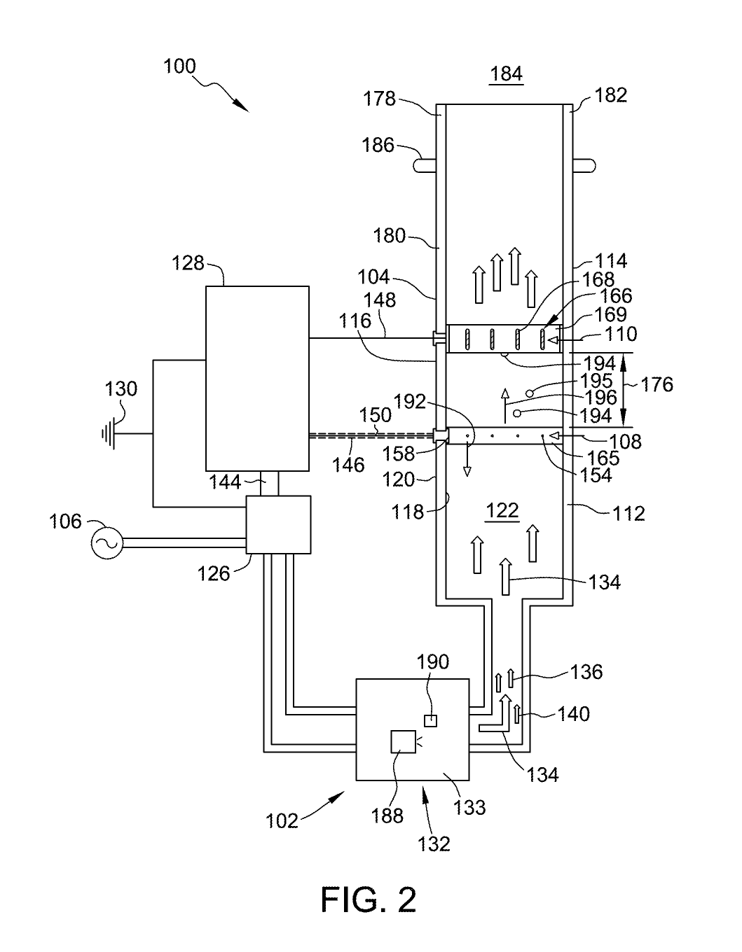

FIG. 1 is a perspective of an electrostatic blower 100. FIG. 2 is a schematic view of electrostatic blower 100 coupled to a combustion system 102. Electrostatic blower 100 includes a housing 104, a power source 106, a corona discharge device 108, and a collector device 110. Housing 104 includes an inlet end 112, a discharge end 114, and a body 116 located between inlet end 112 and discharge end 114. In the exemplary embodiment, body 116 includes an inner surface 118 and an outer surface 120. Inner surface 118 is tubular shape to form a flow channel 122 between inlet end 112 and discharge end 114. Alternatively, inner surface 118 may include any shape to enable housing 104 to function as described herein. Moreover, body 116 includes a temperature resistant, dielectric insulation material such as, but not limited to, a temperature resistant polymer material. In the exemplary embodiment, inner surface 118 is configured to direct a flue gas 134 within flow channel 122, and in particular, to direct a flow of flue gas 134 from inlet end 112 and toward discharge end 114.

Power source 106 is coupled to housing 104 and includes a power supply 124, an appliance logic controller 126, and a high voltage power supply 128. Power source 106 further includes a ground 130 coupled to appliance logic controller 126 and to high voltage power supply 128.

Appliance logic controller 126 is coupled to a gas-fired appliance 132 of combustion system 102. In the exemplary embodiment, gas-fired appliance 132 includes a non-condensing appliance 133 such as, but not limited to, a water heater. Non-condensing appliance 133 is configured to generate flue gas 134 at a temperature that minimizes and/or eliminates condensate production in at least housing 104. A common cause of vent failure for combustion systems 102 is condensation which occurs when water vapor 136 generated in a combustion process cools below a dew point. As water vapor 136 condenses, water vapor 136 combines with combustion by-products 140 present in flue gas 134 to form an acidic solution (not shown). A resultant acid (not shown) will collect and eventually degrade and/or destroy joints and seams (not shown) within combustion system 102, and in particular, within housing 104.

Non-condensing appliance 133 is configured to generate flue gas 134 having a temperature from about 200° F. to about 600° F. More particularly, non-condensing appliance 133 is configured to generate flue gas 134 having a temperature from about 335° F. to about 550° F. Alternatively, non-condensing appliance 133 may generate flue gas 134 having any temperature to minimize and/or eliminate formation of condensation. Moreover, in an alternate embodiment, gas-fired appliance 132 may include a condensing appliance.

Power supply 124 includes an ON/OFF switch 142 configured to control input voltage 144, for example 115 v provided by power source 106. In the exemplary embodiment, high velocity power supply 127 is coupled to ON/OFF switch 142, corona discharge device 108, and collector device 110. In the exemplary embodiment, a shielded high voltage cable 146 couples high voltage power supply 128 to corona discharge device 108 and a ground 198 couples high voltage power supply 128 to collector device 110. High voltage power supply 128 is configured to generate and transmit a supply voltage 150 to corona discharge device 108 to facilitate energizing corona discharge device 108 which ionizes flue gas 134 as described herein. In the exemplary embodiment, high voltage power supply 128 is configured to generate and transmit supply voltage 150 from about 20 Kv to about 80 Kv to corona discharge device 108. More particularly, high voltage power supply 128 is configured to generate and transmit supply voltage 150 of about 30 Kv to corona discharge device 108. Alternatively, high voltage power supply 128 is configured to supply any supply voltage 150 amount to corona discharge device 108 to enable efficient ionization of flue gas 134 by corona discharge device 108.

Corona discharge device 108 is coupled to housing 104 near inlet end 112 and includes an electrode 152 having a first charge 153 such as, for example, a positive charge. In the exemplary embodiment, electrode 152 includes a plurality of electrical wires 154 coupled to high voltage power supply 128 and inner surface 118. More particularly, each electrical wire 154 includes a first wire end 156 coupled to a first portion 158 of inner surface 118 and a second wire end 160 coupled to a second portion 162 of inner surface 118. Each electrical wire 154 further includes a wire body 164 coupled to first wire end 156 and second wire end 158 and extending within flow channel 122. A support ring 165 facilitates coupling electrical wires 154 to inner surface 118. Electrical wires 154 are configured to ionize flue gas 134 present within flow channel 122 as described herein.

Collector device 110 is coupled to housing 104 at a position that is downstream of corona discharge device 108 with respect to flow of flue gas 134 through housing 104 from inlet end 112 and toward discharge end 114. In an embodiment, collector device 110 is coupled to housing 104 near discharge end 114. Collector device 110 includes an electrode 166 having a second charge 155 which is opposite first charge 153. In the exemplary embodiment, electrode 166 has a negative charge. Electrode 166 includes a plurality of metal plates 168 coupled to high voltage power supply 128 through ground 148. Each plate is further coupled to inner surface 118. More particularly, each plate 168 includes a first plate end 170 coupled to first portion 158 and a second plate end 172 coupled to second portion 162. Plates 168 further include a plate body 174 located between first plate end 170 and second plate end 172 and extending within flow channel 122. A support ring 169 facilitates coupling plates 168 to inner surface 118. Plates 168 are configured to attract flue gas 134 that has been ionized by corona discharge device 108 as described herein.

Electrical wires 154 and plates 168 are coupled to inner surface 118 and spaced from each other by a distance 176. In the exemplary embodiment, distance 176 is from about one inch to about twelve inches. More particularly, distance 176 is about three inches. Alternatively, distance 176 can be less than about one inch and more than about twelve inches. Distance 176 is sized to facilitate ionization of flue gas 134 by electrical wires 154 and facilitate attraction of ionized flue gas 134 by and toward plates 168. Moreover, distance 176 is sized to minimize and/or eliminate arcing between electrical wires 154 and plates 168 while facilitating ionization, attraction, and, movement of flue gas 134 present in flow channel 122. Wires 154 and plates 168 may include any number, shape, size, material composition, location placement, and orientations to enable electrostatic blower 100 to function as described herein.

In the exemplary embodiment, electrostatic blower 100 further includes a vent 178 coupled to housing 104. More particularly, vent 178 includes a first vent end 180 coupled to discharge end 114 and a second vent end 182 in flow communication to an environment 184 such as atmospheric environment. Vent 178 includes a pipe, conduit, and/or a duct coupled to discharge end 114 to facilitate venting or exhausting flue gas 134 from housing 104. Moreover, vent 178 includes a corona discharge ring 186 coupled near first vent end 180.

During an exemplary operation, power source 106 delivers input voltage 144, such as 115v, to high voltage power supply 128 and to appliance logic controller 126. Appliance logic controller 126 is configured to activate a combustor 188 to ignite a fuel 190 to produce heat. Flue gas 134 is created by the ignited fuel 190. In the exemplary embodiment, combustor 188 generates flue gas 134 having a temperature from about 200° F. to about 600° F. to minimize and/or eliminate condensation by flue gas 134 within housing 104. Flue gas 134 includes air and combustion by-products and is configured to enter housing 104 at inlet end 112. Inlet end 112 directs flue gas 134 into flow channel 122 and toward corona discharge device 108.

High voltage power supply 128 is configured to receive input voltage 144 from power source 106. Moreover, high voltage power supply 128 is configured generate and transmit supply voltage 150 to corona discharge device 108. In the exemplary embodiment, high voltage power supply 128 transmits supply voltage 150 to corona discharge device 108 a voltage in a range from about 20 Kv to about 80 Kv. Electrical wires 154 are configured to receive supply voltage 150 and produce a current 192.

Current 192 is configured to flow from electrical wires 154 and into flue gas 134 present in flow channel 122 to facilitate a breakdown of flue gas 134, known as corona discharge. More particularly, current 192 ionizes flue gas 134 to facilitate forming ions 194 of flue gas 134. Collector plates 168 are configured to attract ions 194, based on opposite second charge 155 of plates 168. The ion attraction facilitates movement of ions 194 from electrical wires 154 and toward plates 168. While moving toward collector plates 168, ions 194 collide with other gas molecules 195 such as, for example air molecules and combustion by-product molecules, present within flow channel 122, to facilitate creating a head pressure 196 which moves ions 194 and other gas molecules 195 within flow channel 122. Ions 194 and collided gas molecules 195 combine and move from corona discharge device 108 and toward collector plates 168.

Plates 168 are configured to attract ions 194 to facilitate neutralizing ions 194 based on opposite, second flue charge 155 of plates 168 as compared to positive first charge 153 of electrical wires 154. Head pressure 196 continues to move flue gas 134, from corona discharge device 108, through flow channel 122, and past collector plates 168. Vent 178 is configured to direct flue gas 134 from collector plates 168 and into environment such as atmospheric environment 184 which is located away from non-condensing appliance 133. Corona discharge ring 186 is configured to distribute the electric field gradient within vent 178 to facilitate minimizing and/or eliminating corona discharge effects within vent 178.

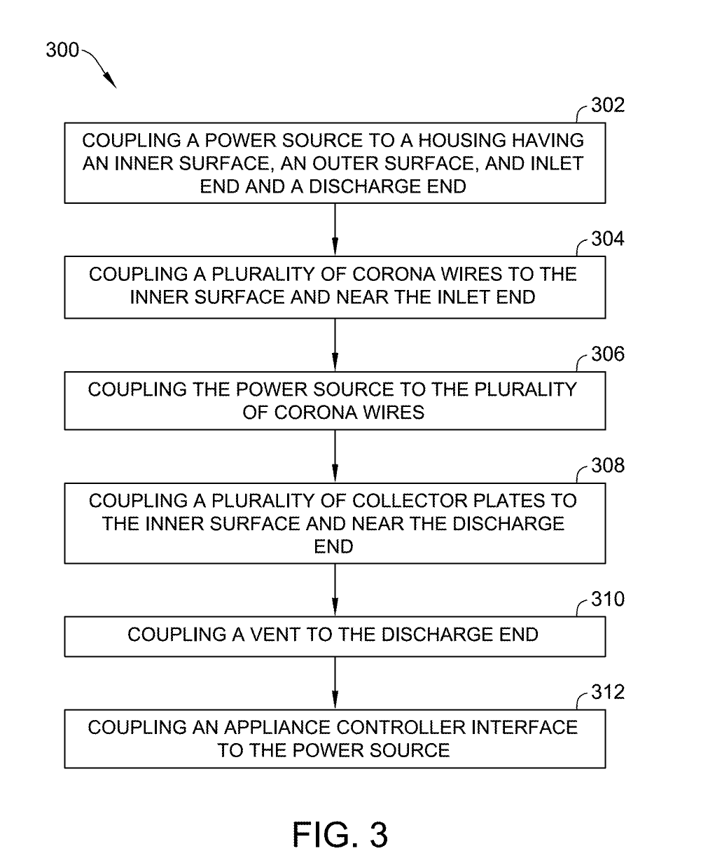

FIG. 3 illustrates an exemplary flowchart illustrating a method 300 of assembling an electrostatic blower, for example electrostatic blower 100 (shown in FIG. 1). The electrostatic blower includes a housing, for example housing 104 (shown in FIG. 1), which has an inner surface and an outer surface, for example inner surface 118 and outer surface 120 (shown in FIG. 1). The electrostatic blower further includes a power source, such as power source 106 (shown in FIG. 2), an appliance logic controller, for example appliance logic controller 126 (shown in FIG. 1), a corona discharge device, such as corona discharge device 108 (shown in FIG. 1), and a collector device, for example collector device (shown in FIG. 1).

Method 300 includes coupling 302 the power source to the housing. A plurality of corona wires, for example corona wires 154 (shown in FIG. 1), of the corona discharge device, is coupled 304 to the housing inner surface near a housing inlet end, such as inlet end 112 (shown in FIG. 1). The power source is also coupled 306 to the corona wires. Method 300 also includes coupling 308 a plurality of collector plates, for example collector plates (shown in FIG. 1), to the inner surface and near the discharge end. In the exemplary method 300, coupling the collector plates to the inner surface includes coupling the collector plates to the inner surface at a distance, such as distance 176 (shown in FIG. 2), from the plurality of wires at about three inches. Moreover, in the exemplary method 300, a vent, for example vent (shown in FIG. 1), is coupled 310 to the discharge end. Method 300 further includes coupling 312 the appliance logic controller to the power source.

A technical effect of the systems and methods described herein includes at least one of: using a fanless motor less draft inducer to move flue gas; (b) ionizing flue gas with an electrostatic blower, (c) neutralizing the ionized flue gas, (d) venting the flue gas, (e) increasing an operating efficiency of combustion system, and (f) decreasing manufacturing installation, operations and maintenance costs.

The exemplary embodiment described herein facilitate mobbing and venting flue gases from a combustion system, such as a water heater or furnace, and away from a facility. More particularly, the embodiment described herein use an electrostatic blower to ionize the flue gas and to attack the ionized flue gas to a collector. The electrostatic blower facilitates movement of the flue gas from the combustion system without the use of an electromechanical fan and/or motor. The embodiments described herein decrease work space and noise of the combustion system. Still further, the exemplary embodiments increase efficiency and reduce operating and maintenance costs associated with the combustion system and/or electrostatic blower.

Exemplary embodiments of an electrostatic blower and methods for assembling the electrostatic blower are described above in detail. The methods and systems are not limited to the specific embodiments described herein, but rather, components of systems and/or steps of the methods may be utilized independently and separately from other components and/or steps described herein. For example, the methods may also be used in combination with other manufacturing systems and methods, and are not limited to practice with only the systems and methods as described herein. Rather, the exemplary embodiment can be implemented and utilized in connection with many other combustion applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An electrostatic blower for moving a flue gas, said electrostatic blower comprising:
a power source;
a housing coupled to said power source and comprising an inlet end and a discharge end;
a corona discharge device coupled to said power source and to said housing, said corona discharge device configured to ionize the flue gas; and
a collector device coupled to said housing at a position downstream from said corona discharge device with respect to a flow of the flue gas within said housing, said collector configured to attract the ionized flue gas from said corona discharge device.

2. The electrostatic blower of claim 1, wherein said power source is configured to deliver electricity from about 20 Kv to about 80 Kv to said corona discharge device.

3. The electrostatic blower of claim 1, wherein said power source is configured to deliver electricity of about 30 Kv to said corona discharge device.

4. The electrostatic blower of claim 1, wherein said housing comprises a dielectric insulation material.

5. The electrostatic blower of claim 1, wherein said corona discharge device and said collector device are coupled to said housing and spaced from each other by a distance from about one inch to about twelve inches.

6. The electrostatic blower of claim 1, wherein said corona discharge device is configured to have a first charge and said collector device is configured to a second charge which is different than the first charge.

7. The electrostatic blower of claim 1, wherein said corona discharge device comprises a plurality of wires coupled to said housing.

8. The electrostatic blower of claim 1, wherein said collector device comprises a plurality of metal plates.

9. The electrostatic blower of claim 1, further comprising a vent coupled to said discharge end.

10. The electrostatic blower of claim 1, further comprising an appliance logic controller coupled to said power supply.

11. A gas appliance comprising:
a combustor configured to combust a fuel and generate a flue gas;
an electrostatic blower coupled to said combustor, said electrostatic blower comprising:
a power source;
a housing coupled to said power source and comprising an inlet end and a discharge end;
a corona discharge device coupled to said power source and to said housing, said corona discharge device configured to ionize the flue gas; and
a collector device coupled to said housing at a position downstream from said corona discharge device with respect to a flow of the flue gas within said housing, said collector device configured to attract the ionized flue gas from said corona discharge device; and
a vent coupled to said discharge end.

12. The gas appliance of claim 11, wherein said combustor comprises a non-condensing combustor.

13. The gas appliance of claim 11, wherein said combustor is configured to generate the flue gas having a temperature from about 200° F. to about 600° F.

14. The gas appliance of claim 11, further comprising a corona ring coupled to said vent.

15. The gas appliance of claim 11, wherein said corona discharge device and said collector device are coupled to said housing and spaced from each other by a distance from about one inch to about twelve inches.

16. The gas appliance of claim 11, wherein said corona discharge device and said collector device are coupled to said housing and spaced from each other by a distance of about three inches.

17. A method of assembling an electrostatic blower, said method comprising:
coupling a power source to a housing having an inner surface, an outer surface, an inlet end and a discharge end;
coupling a plurality of corona wires to the inner surface near the inlet end;
coupling the power source to the plurality of corona wires; and
coupling a plurality of collector plates to the inner surface near the discharge end.

18. The method of assembling the electrostatic blower of claim 12, wherein coupling the plurality of collector plates comprises coupling the plurality of collector plates to the inner surface about 3 inches from the plurality of corona wires.

19. The method of assembling the electrostatic blower of claim 17, further comprising coupling a vent to the discharge end.

20. The method of assembling the electrostatic blower of claim 17, further comprising coupling an appliance logic controller to the power source.
